(19) United States
(12) Patent Application Publication
(10) Pub. No.: US 2012/0020103 A1
(43) Pub. Date: Jan. 26, 2012

(54) VEHICLE LAMP UNIT

(76) Inventor: Hidetaka Okada, Tokyo (JP)

(21) Appl. No.: 13/189,725

(22) Filed: Jul. 25, 2011

(30) Foreign Application Priority Data
Jul. 23, 2010 (JP) 2010-165438

(51) Int. Cl. B60Q 1/00

(52) U.S. Cl. 362/510

(57) ABSTRACT

A vehicle lamp unit can have a plurality of lamp functions with a compact and low-cost configuration. The vehicle lamp unit can include two light sources of the same type and a light guide body. The light guide body includes two light guiding blocks corresponding to the respective light sources. Each light guiding block can include a light incidence portion, a first reflection portion, a second reflection portion and a light exiting portion. The light incidence portion can receive the light from the light source to collimate the light toward the first reflection portion. The first reflection portion can reflect the light toward the second reflection portion and the second reflection portion can reflect the light toward the light exiting portion. Each of the first and second light guiding blocks can include a first region from the light incidence portion to the first reflection portion and a second region from the second reflection portion to the light exiting portion, and the first region of the first light guiding block has a different color from the first region of the second light guiding block while the second regions of the first and second light guiding blocks are untinted.

This application claims the priority benefit under 35 U.S.C. §119 of Japanese Patent Application No. 2010-165438 filed on Jul. 23, 2011, which is hereby incorporated in its entirety by reference.

### TECHNICAL FIELD

The presently disclosed subject matter relates to a vehicle lamp unit, and in particular, to a vehicle lamp unit to be installed in a rear part or section of a vehicle body as a rear lamp, a tail lamp, a stop lamp, and the like.

### BACKGROUND ART

A conventional vehicle lamp unit for use as a signal light or the like of an automobile can include a light source, and a light guiding unit having a light exiting surface that is configured to guide light emitted from the light source to the light exiting surface through which the guided light exits. This type of vehicle lamp unit is disclosed in Japanese Patent Application Laid-Open No. 2005-5275, for example.

In many vehicles, various lamps with different colors and/or operated in various light emitting modes can be installed, such as a rear or lamp, a stop lamp, a turn-signal lamp, and the like.

With the above conventional vehicle lamp unit, however, a set of a light source and a light guiding unit can only achieve a single lamp function. In this case, to achieve various functions, a plurality of different sets of a light source and a light guiding unit are required to be installed. However, if multiple sets of light sources and light guides are involved, it is difficult to design a compact lamp layout having the plurality of sets. If various colored lamps are required, a plurality of colored light sources must also be provided. Since the same type light source cannot be used in the above described lamps, assembly cost due to complex assembly steps may be increased in addition to parts management cost.

### SUMMARY

The presently disclosed subject matter was devised in view of these and other problems and features and in association with the conventional art. According to an aspect of the presently disclosed subject matter, a vehicle lamp unit can have a plurality of lamp functions with a compact and low-cost configuration.

According to another aspect of the presently disclosed subject matter, a vehicle lamp unit can include: a first light source and a second light source configured to emit light in a direction of an optical axis, the first and second light sources being disposed side by side along a direction perpendicular to the optical axis; and a light guide body disposed in front of the first and second light sources. The light guide body can have a first light guiding block and a second light guiding block each light guiding block configured to guide light from the corresponding one of the first and second light sources. Each of the first and second light guiding blocks can be composed of a light incidence portion, a first reflection portion, a second reflection portion, and a light exiting portion. The light incidence portion can be configured to allow the light emitted from the corresponding light source to enter the light guide body while collimating the light along the optical axis in the optical axis direction. The first reflection portion can be configured to be inclined by 45 degrees with respect to the optical axis and reflect the light entering the light guide body through the light incidence portion in a direction perpendicular to the optical axis inside the light guide body. The second reflection portion can be configured to reflect the light having been reflected by the first reflection portion in the optical axis direction inside the light guide body. The light exiting portion can be configured to allow the light reflected by the second reflection portion to exit the light guide body through the light exiting portion. Each of the first and second light guiding blocks can be configured to include a first region which extends from the light incidence portion to the first reflection portion and a second region which extends from the second reflection portion to the light exiting portion. The first region of the first light guiding block can have a different color from the first region of the second light guiding block while the second regions of the first and second light guiding blocks can be untinted.

In the vehicle lamp unit with the above configuration, the first region can be configured to be positioned in a direction perpendicular to the optical axis with respect to the light exiting portion.

In the vehicle lamp unit with the above configuration, the first light guiding block and the second light guiding block can be configured to be line symmetric to each other.

In the vehicle lamp unit with the above configuration, the light incidence portion can be configured to include a first incidence surface having a convex shape projected toward the light source at a center of the light incidence portion, a second incidence surface composed of a substantial cylindrical inner wall surrounding the first incidence surface, and an incidence-portion reflection surface surrounding the second incidence surface so that the light radially emitted from the light source can enter the light guide body through the first incidence surface and the second incidence surface while the light entering the first incidence surface is refracted by the first incidence surface to be collimated along the optical axis and the light entering the second incidence surface is refracted by the second incidence surface and then reflected by the incidence-portion reflection surface to be collimated along the optical axis.

In the vehicle lamp unit with the above configuration, the second reflection portions can be configured to include a plurality of reflection surfaces formed on both sideward rear surfaces of the light guide body, the plurality of reflection surfaces forming a continuous stepped surface together with flat surfaces arranged in between the reflection surfaces.

The vehicle lamp unit made in accordance with the principles of the presently disclosed subject matter can include the two light sources and the light guide body having the two light guiding blocks each configured to guide light from the corresponding one of the two light sources. The first region which extends from the light incidence portion to the first reflection portion of the first light guiding block has a different color from the first region of the second light guiding block. The second regions of the first and second light guiding blocks are untinted. With the vehicle lamp unit having the above configuration, the respective light exiting portions can be observed while being tinted with different colors corresponding to the respective first regions of the first and second light guiding blocks. In addition, these first and second light sources can be configured to be separately controlled so that the respective light exiting portions can be illuminated with light with different light projecting modes, meaning that a plurality of lamp functions can be achieved by this single vehicle lamp unit.

Since the vehicle lamp unit with the above configuration can be composed only of two light sources and a single light guiding body, the entire lamp layout of the vehicle lamp unit can be made compact as compared with a conventional lamp that requires a plurality of sets of a light source and a light guide body corresponding to the number of the desired lamp functions. The two light sources employed are the same type (and for example, for emitting the same colored light). When compared with the case where a plurality of colored light sources are provided to achieve a lamp for projecting various colored beams of light, the vehicle lamp unit with the above configuration can reduce assembly costs due to simple assembly steps in addition to reduced parts management cost.

The light emitted from the light source can enter the light guide body through the corresponding light incidence portion so as to be collimated along the optical axis direction and then can be reflected by the first reflection portion by 45 degrees with respect to the optical axis so that the light is directed in a direction perpendicular to the optical axis inside the light guide body. In this first region from the light incidence portion to the first reflection portion, the light passing therethrough can be colored according to the color of the light guide body while the light path length through which the light passes can be made even. Accordingly, the chroma of the light having passed through the region can be made even, whereby the light exiting portion can be illuminated with the colored light without color unevenness.

### BRIEF DESCRIPTION OF DRAWINGS

These and other characteristics, features, and advantages of the presently disclosed subject matter will become clear from the following description with reference to the accompanying drawings, wherein:

FIG. 1 is a front view of a vehicle lamp unit made in accordance with the an embodiment of the presently disclosed subject matter;

FIG. 2 is a cross sectional view of the vehicle lamp unit taken along line II-II of FIG. 1;

FIG. 3 is a cross sectional view of the vehicle lamp unit taken along line III-III of FIG. 1;

FIG. 4 is a schematic view illustrating the optical paths in accordance with an embodiment the vehicle light unit; and

FIG. 5 is a cross sectional view of a modified example of the vehicle light made in accordance with an embodiment of the presently disclosed subject matter.

### DETAILED DESCRIPTION OF EXEMPLARY EMBODIMENTS

A description will now be made below to vehicle lamp units of the presently disclosed subject matter with reference to the accompanying drawings in accordance with exemplary embodiments. However, the presently disclosed subject matter is not limited to the illustrated embodiments and examples in any way.

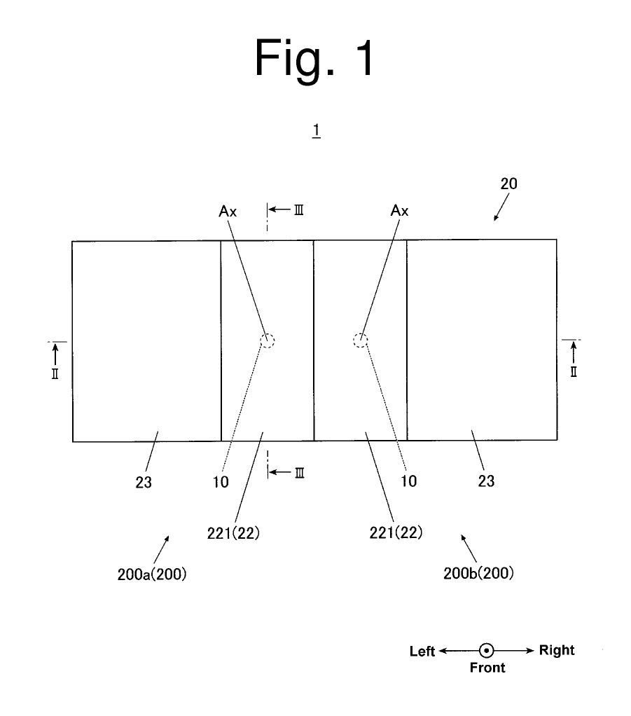

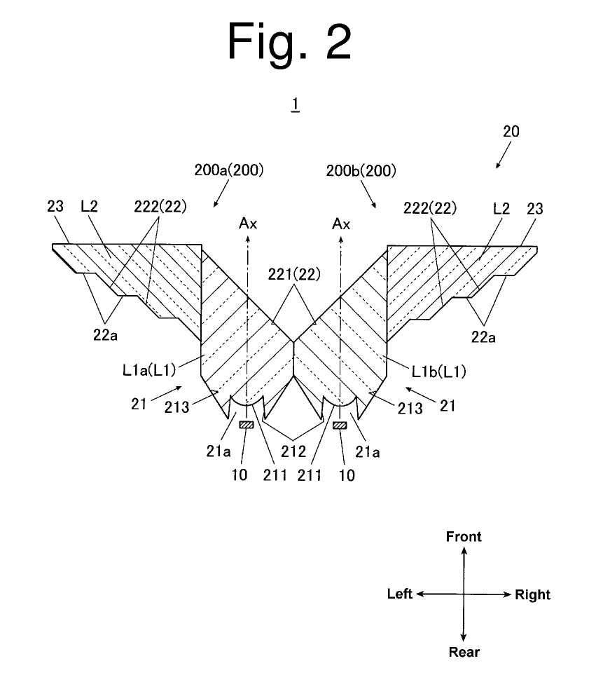

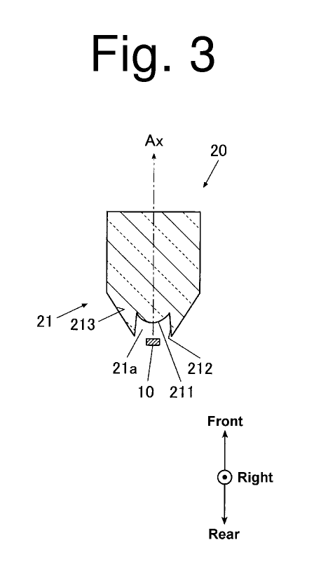

FIG. 1 is a front view of a vehicle lamp unit made in accordance with an embodiment of the presently disclosed subject matter. FIG. 2 and FIG. 3 are cross sectional views of the vehicle lamp unit taken along line II-II and line III-III of FIG. 1, respectively.

As illustrated in these drawings, the vehicle lamp unit 1 can be configured to include two light sources 10 and a light guide body 20 disposed in front of these light sources 10. The vehicle lamp unit with this configuration can be accommodated within a light chamber defined by a not-shown housing and a not-shown transparent front cover, for example.

Each of the two light sources 10 can be a light emitting body for emitting white light, such as a light emitting diode (LED) and the like, and have an optical axis Ax in the forward direction. The light sources 10 can be mounted on a not-shown substrate side by side and/or adjacent one another in a direction perpendicular to the optical axis Ax (or left-to-right direction) so as to emit light radially around the optical axis Ax in the front direction.

The light guide body 20 can be configured to include two light guiding blocks 200 symmetrically formed on right and left sides, i.e., adjacent to each other (on a line symmetric to each other). These two light guiding blocks 200 can be connected to each other and can correspond to the two light sources 10 so that the light guiding blocks 200 can separately guide light emitted from the corresponding two light sources 10. Accordingly, the vehicle lamp unit of the illustrated embodiment can have a rectangular plan shape composed of rectangular plan shapes of the two light guiding blocks 200 when viewed from its front side, as shown in FIG. 1.

Specifically, each of the two light guiding blocks 200 can be configured to include a light incidence portion 21, a light guiding portion 22, and a light exiting portion 23. The light incidence portion 21 can be configured to allow light emitted from the light source 10 to enter the light guide body 20. The light exiting portion 23 can be configured to allow light guided through the light guide body 20 to exit from the light guide body 20. The light guiding portion 22 can be configure to guide the light entering through the light incidence portion 21 to the light exiting portion 23.

The light incidence portion 21 can project toward the rear side at the rear surface of the light guide body 20 (or surface closest to the light source 10) so as to face to the corresponding light source 10. Specifically, the light incidence portion 21 can be formed to have a truncated conical outer shape with the optical axis Ax serving as a rotational symmetric axis. Further, a concave portion 21 opening rearward can be formed in the truncated conical shape of the light incidence portion 21.

On the bottom portion of the concave portion 21, a first incidence surface 211 can be formed so as to have a convex shape (aspheric shape) projected rearward with respect to the optical axis Ax serving as a rotational symmetric axis and facing to the corresponding light source 10. The first incidence surface 211 can be designed to have a focus at or near the position of the corresponding light source 10, whereby the light emitted from the light source 10 can enter the light guide body 20 through the first incidence surface 211 while being refracted in a direction along the optical axis Ax (or optical axis Ax direction).

An inner peripheral surface of the concave portion 21a around the first incidence surface 211 can serve as a second incidence surface 212. The second incidence surface 212 can be formed from a substantial cylindrical inner wall shape (or part of conical inner surface) surrounding the corresponding light source 10 and configured to allow the light emitted from the light source 10 sideward and not reaching the first incidence surface 211 to enter the light guide body 20 through the second incidence surface 212.

The outer circumference surface of the light incidence portion 21 can be configured as a first reflection surface (an incidence-portion reflection surface) 213 surrounding the second incidence surface 212. The light emitted from the light source 10 and passing through the second incidence surface 212 can be reflected by the first reflection surface 213 to the inside of the light guide body 20 to be collimated along the optical axis.

The light guide portion 22 (the light guide portion can also be referred to as a light (travel direction) control portion) can be configured to include a second reflection surface 221 formed in the front surface of the light guide body 20 in part (corresponding to the “first reflection portion” in the claims), and a plurality of third reflection surfaces 222 formed in the sideward rear surface of the light guide body 20 (corresponding to the “second reflection portion” in the claims).

The second reflection surface 221 can be formed on the front surface of the light guide body 20 so as to be positioned in the optical axis Ax with respect to the corresponding light incidence portion 21. The second reflection surface 221 can be inclined by 45 degrees with respect to the optical axis Ax so that the light entering the light guide body 20 through the light incidence portion 21 and travelling in the optical axis Ax direction can be reflected in a direction perpendicular to the optical axis Ax direction (or left-to-right direction) within the light guide body 20. The second reflection surface 221 can be formed by a reflection deposition film such as an aluminum deposition film so that the light cannot exit through the second reflection surface 221 to the outside of the light guide body 20 but can be reflected sideward.

The plurality of third reflection surfaces 222 can be formed on the sideward rear surface of the light guide body 20. Specifically, the light guide body 20 can have a plurality of rear flat surfaces 22a arranged in a stepped manner at both sideward portions thereof. Then, the flat surfaces 22a can be configured to be positioned more forward with the increased distance from the optical axis Ax, and be perpendicular to the optical axis Ax. The respective third reflection surfaces 222 can be inclined by 45 degrees with respect to the optical axis Ax and disposed between the flat surfaces 22a alternately so as to form a continuous stepped surface together with the flat surfaces 22a. Accordingly, the third reflection surfaces 222 are disposed on the right and left sides with respect to the second reflection surfaces 221, so that the light reflected by the second reflection surfaces 221 leftward and rightward can be reflected by these third reflection surfaces 222 in the optical axis Ax direction.

The light exiting portion 23 can be formed on the front surface of the light guide body 20 so as to face the third reflection surfaces 222 in the optical axis Ax direction. The light exiting portion 23 can be configured to allow the light reflected by the third reflection surfaces 222 within the light guide body 20 to exit from the light guide body 20. Note that although not shown in the drawings, the light exiting portions 23 can be configured to include lens-cuts according to a desired light emission mode.

Each of the light guiding blocks 200 can be configured to include a first light guiding region L1 and a second light guiding region L2. The first light guiding region L1 can be configured to include the region from the light incidence portion 21 to the second reflection surface 221 (or the first reflection portion) and formed from a tinted resin. The second light guiding region L2 can be configured to include the region from the portion after the first light guiding region L1 (or the second reflection portion) to the light exiting portion 23 and formed from a clear (untinted) resin. The boundary between the first and second light guiding regions L1 and L2 can be a plane that is parallel with the optical axis Ax. Further, the first light guiding regions L1 can have different colors from each other in the respective light guiding blocks 200. For example, the first light guiding region L1 of the light guiding block 200a may be formed from a red colored resin while the first light guiding region L1 of the light guiding block 200b may be formed from an amber colored resin. The combination of the different colors is not limited to this, but may be any combinations of colors (even tinted and untinted) as long as the colors can be utilized in a vehicle lamp according to various vehicle specifications/regulations.

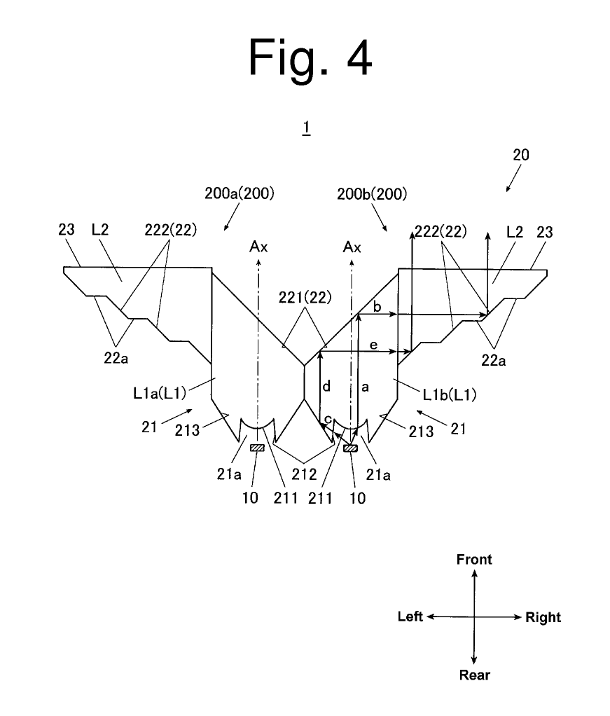

A description will now be given of the light travelling within the vehicle lamp unit while one of the right and left light guiding blocks 200 is exemplified. As shown in the right part of FIG. 4, the light source 10 is energized to emit light in the optical axis Ax direction radially. Then, the light reaching the first incidence surface 211 of the light incidence portion 21 can enter the light guide body 20 while being refracted by the first incidence surface 211 toward the optical axis Ax. On the other hand, the light emitted laterally from the light source 10 can enter the light guide body 20 through the second incidence surface 212 and then be reflected by the first reflection surface 213 in the optical axis Ax direction within the light guide body 20. As a result, the light emitted from the light source 10 and reaching and entering the light guide body 20 can be collimated by the light incidence portion 21 (including the first light incidence surface 211, the second light incidence surface 212 and the first reflection surface 213) with respect to the optical axis Ax direction. Then, the collimated light traveling in the optical axis Ax direction within the light guide body 20 can be reflected by the second reflection surface 211 to the right side (and exit the first light guiding region L1b). The reflected light can enter the second light guiding region L2 and then reach the plurality of third reflection surfaces 222. The respective third reflection surfaces 222 can reflect the received light toward the optical axis Ax direction. The reflected light can be directed to the light exiting portion 23, so that the light exiting portion 23 can be illuminated.

During the travelling through the first light guiding region L1 of the light guiding block 200, the white light emitted from the light source 10 can be colored by the color of the first light guiding region L1, and then the colored light can travel through the untinted second light guiding region L2 and exit through the light exiting portion 23 as is. Namely, the light exiting portion 23 can be illuminated with the colored light with the color of the first light guiding region L1.

In the above mentioned combination, for example, the light exiting surface 23 of the light guiding block 200a can project red light (or can be illuminated with red light) while the light exiting surface 23 of the light guiding block 200b can project amber light (or can be illuminated with amber light). Accordingly, by separately controlling the two light sources 10, the light exiting surfaces 23 can be illuminated with different light emission modes. In other words, for example, the light exiting surface 23 of the light guiding block 200a can function as a stop lamp and a rear or tail lamp with the projected red light while the light exiting surface 23 of the light guiding block 200b can function as a turn-signal lamp with the projected amber light. In this way, the vehicle lamp unit 1 can achieve multiple lamp functions with a single unit.

Since the vehicle lamp unit 1 with the above configuration can be composed only of the two light sources 10 and the single light guiding body 20, the vehicle lamp unit 1 can be made compact as an entire lamp layout when compared with a conventional lamp that requires a plurality of sets of a light source and a light guide body corresponding to the number of the desired lamp functions. This can improve the design flexibility as well as provide weight reduction.

In addition, the two light sources 10 employed can be the same type for emitting the same colored light (white light, for example). When compared with the case where a plurality of colored light sources should be provided to achieve a lamp for projecting various colored beams of light, the vehicle lamp unit 1 with the above configuration can reduce assembly cost due to simplified assembly steps in addition to reduced parts management cost.

The light emitted from the light source 10 can enter the light guide body 20 through the corresponding light incidence portion 21 so as to be collimated along the optical axis Ax direction and then can be reflected by the second reflection surface 221 of the first reflection portion by 45 degrees with respect to the optical axis Ax so that the light is directed in a direction perpendicular to the optical axis Ax inside the light guide body 20. In this first light guiding region L1 from the light incidence portion 21 to the first reflection portion, the light passing therethrough can be colored according to the color of the light guide body 20 while the light path length through which the light passes can be made even. Specifically, as shown in FIG. 4, the light can travel through one light path such that the light enters the light guide body 20 through the first light incidence surface 211 (in the first light guiding region L1) and is reflected by the second reflection surface 221 to exit the first light guiding region L1. In this case the total light path length can be the length (a+b). The light can travel through another light path such that the light enters the light guide body 20 through the second light incidence surface 211 (in the first light guiding region L1) and is reflected by the first reflection surface 213 and then by the second reflection surface 221 to exit the first light guiding region L1. In this case the total light path length can be the length (c+d+e). In accordance with the presently disclosed subject matter the light guide body 20 can be designed so that the length (a+b) is made equal to, or substantially made equal to, the length (c+d+e).

Accordingly, the chroma of the light having passed through the first light guiding region L1 with the same travelling distance can be made even, whereby the light exiting portion 23 can be illuminated with the colored light without color unevenness.

The first light guiding regions L1 can be arranged at the right and left sides of the light exiting surfaces 23, respectively. Accordingly, when the light exiting surfaces 23 are observed from its front side while the light sources are not energized, the first light guiding regions L1 cannot be observed through the light exiting surfaces 23. Namely, only the untinted second light guiding regions L2 can be observed through the light exiting surfaces 23. This configuration can enhance the difference between the light emission state and the non-light emission state (colored red/amber or not), thereby increasing the product value.

In addition, the light incidence portion 21 and the light projected rearward can provide a thickness to the light guiding body 20 giving it a more luxurious appearance.

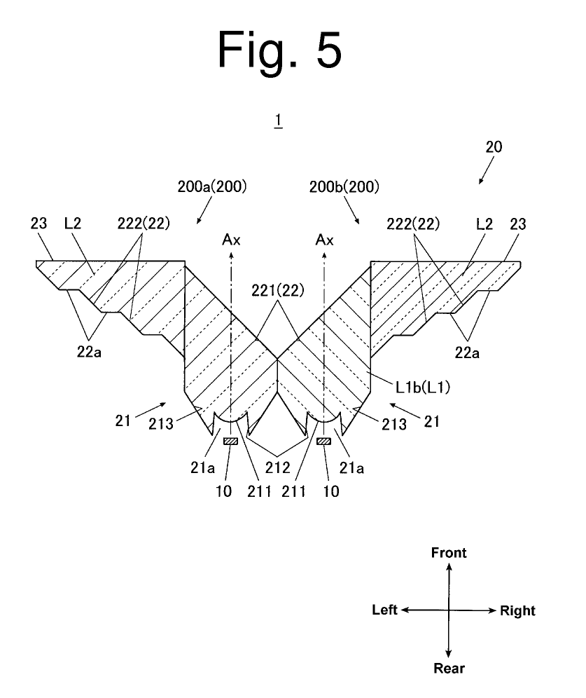

Next, a modification will now be described with reference to FIG. 5. In the previous exemplary embodiment, the first light guiding region L1a of the one light guiding block 200a is made of a red resin. In this modification, the light guiding block 200a can be entirely made of a clear resin from the first light guiding region to the second light guiding region L2. Namely, this means that the first light guiding region from the light incidence portion to the first reflection portion of one light guiding block has a different color from the first light guiding region of the second light guiding block and can include the case where one first light guiding region can be tinted while the other first light guiding region can be untinted while the following second light guiding region is also untinted. With this modification, the light exiting portion 23 of the light guiding block 200a can be allowed to function not as a stop lamp or rear or tail lamp, but as a positioning lamp or a day-time running lamp emitting white light. In this manner, the color of the first light guiding region L1 can be appropriately changed in accordance with the combination of desired lamp functions.

Further, the light sources 10 can be any light source in accordance with the desired color of the first light guiding region L1 and/or combination of desired lamp functions. For example, the light sources can emit red light, amber light, or the like.

When a white LED light source is employed, various color variations can be achieved by adjusting the color combination of the light guide body. Also, using a simple white LED light source can facilitate parts management when compared with the use of two different light sources for different colors.

On the other hand, if a red LED light or an amber LED light is employed, the degree of coloring of the light guide body can be decreased as much as possible, meaning that the light transmittance of the light guide body can be increased by the coloring of the light source. Accordingly, light loss during the colored light guide body travelling through the light guide body can be minimized advantageously.

Furthermore, the two light sources may emit the same colored light or different colored light from each other in accordance with the desired color of the first light guiding region L1 and/or combination of desired lamp functions.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle lamp unit comprising:
a first light source and a second light source configured to emit light in a direction of an optical axis, the first and second light sources being disposed adjacent each other along a direction perpendicular to the optical axis; and
a light guide body disposed in front of the first and second light sources, wherein:
the light guide body has a first light guiding block and a second light guiding block each configured to guide light from a corresponding one of the first and second light sources;
each of the first and second light guiding blocks includes a light incidence portion, a first reflection portion, a second reflection portion, and a light exiting portion,
the light incidence portion configured to allow the light emitted from the corresponding light source to enter the light guide body while collimating the light along the optical axis in the optical axis direction,
the first reflection portion configured to be inclined by 45 degrees with respect to the optical axis and reflect the light entering the light guide body through the light incidence portion in a direction perpendicular to the optical axis inside the light guide body,
the second reflection portion configured to reflect the light reflected by the first reflection portion in the optical axis direction inside the light guide body,
the light exiting portion configured to allow the light reflected by the second reflection portion to exit the light guide body through the light exiting portion;
each of the first and second light guiding blocks configured to include a first region from the light incidence portion to the first reflection portion and a second region from the second reflection portion to the light exiting portion; and
the first region of the first light guiding block having a different color from the first region of the second light guiding block while the second region of the first and second light guiding blocks are untinted.

2. The vehicle lamp unit according to claim 1, wherein the first region is configured to be positioned in a direction perpendicular to the optical axis with respect to the light exiting portion.

3. The vehicle lamp unit according to claim 1, wherein the first light guiding block and the second light guiding block are configured to be in-line symmetric to each other.

4. The vehicle lamp unit according to claim 2, wherein the first light guiding block and the second light guiding block are configured to be in-line symmetric to each other.

5. The vehicle lamp unit according to claim 1, wherein the light incidence portion is configured to include a first incidence surface having a convex shape projected toward the light source at a center of the light incidence portion, a second incidence surface composed of a substantial cylindrical inner wall surrounding the first incidence surface, and an incidence-portion reflection surface surrounding the second incidence surface so that the light radially emitted from the light source can enter the light guide body through the first incidence surface and the second incidence surface while the light entering the first incidence surface is refracted by the first incidence surface to be collimated along the optical axis and the light entering the second incidence surface is refracted by the second incidence surface and then reflected by the incidence-portion reflection surface to be collimated along the optical axis.

6. The vehicle lamp unit according to claim 2, wherein the light incidence portion is configured to include a first incidence surface having a convex shape projected toward the light source at a center of the light incidence portion, a second incidence surface composed of a substantial cylindrical inner wall surrounding the first incidence surface, and an incidence-portion reflection surface surrounding the second incidence surface so that the light radially emitted from the light source can enter the light guide body through the first incidence surface and the second incidence surface while the light entering the first incidence surface is refracted by the first incidence surface to be collimated along the optical axis and the light entering the second incidence surface is refracted by the second incidence surface and then reflected by the incidence-portion reflection surface to be collimated along the optical axis.

7. The vehicle lamp unit according to claim 3, wherein the light incidence portion is configured to include a first incidence surface having a convex shape projected toward the light source at a center of the light incidence portion, a second incidence surface composed of a substantial cylindrical inner wall surrounding the first incidence surface, and an incidence-portion reflection surface surrounding the second incidence surface so that the light radially emitted from the light source can enter the light guide body through the first incidence surface and the second incidence surface while the light entering the first incidence surface is refracted by the first incidence surface to be collimated along the optical axis and the light entering the second incidence surface is refracted by the second incidence surface and then reflected by the incidence-portion reflection surface to be collimated along the optical axis.

8. The vehicle lamp unit according to claim 4, wherein the light incidence portion is configured to include a first incidence surface having a convex shape projected toward the light source at a center of the light incidence portion, a second incidence surface composed of a substantial cylindrical inner wall surrounding the first incidence surface, and an incidence-portion reflection surface surrounding the second incidence surface so that the light radially emitted from the light source can enter the light guide body through the first incidence surface and the second incidence surface while the light entering the first incidence surface is refracted by the first incidence surface to be collimated along the optical axis and the light entering the second incidence surface is refracted by the second incidence surface and then reflected by the incidence-portion reflection surface to be collimated along the optical axis.

9. The vehicle lamp unit according to claim 1, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

10. The vehicle lamp unit according to claim 2, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

11. The vehicle lamp unit according to claim 3, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

12. The vehicle lamp unit according to claim 4, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

13. The vehicle lamp unit according to claim 5, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

14. The vehicle lamp unit according to claim 6, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

15. The vehicle lamp unit according to claim 7, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

16. The vehicle lamp unit according to claim 8, wherein the second reflection portions are configured to include a plurality of reflection surfaces formed on both sideward rear surfaces of the light guide body, the plurality of reflection surfaces forming a continuous stepped surface together with flat surfaces arranged in between the reflection surfaces.

17. The vehicle lamp unit according to claim 1, having a rectangle plan shape composed of rectangle plan shapes of the first and second light guiding blocks when viewed from its front side.
